(19) United States
(12) Patent Application Publication
(10) Pub. No.: US 2009/0291242 A1
(43) Pub. Date: Nov. 26, 2009

(54) SYSTEM AND METHOD SUPER ABSORBENT POLYMER FOR BALLASTING A DEVICE HAVING A BALLAST BASE

(76) Inventor: Frank J. Owens III, Atlanta, GA (US)

Correspondence Address: PASSE' INTELLECTUAL PROPERTY, LLC, 1717 BRASSFIELD RD., RALEIGH, NC, 27614, US

(21) Appl. No.: 12/468,903

(22) Filed: May 20, 2009

Related U.S. Application Data
(60) Provisional application No. 61/128,299, filed on May 21, 2008.

(51) Int. Cl. B32B 1/06; C08L 31/06

(52) U.S. Cl. 428/35.7; 524/556

(57) ABSTRACT

The present invention relates to a system and method for providing ballast to a portable device with a fillable ballast base such as a basketball stand, an umbrella stand, a road barrier or the like. The base is filled with a super absorbent polymer and water to produce a solid material, such as a gel, so that liquid will not leak out during use like water alone would and does not have the difficult filling issues and the storage issues like sand used for ballast.

This application claims priority of provisional application 61/128,299 filed on May 21, 2008 and is incorporated in its entirety herein by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method of ballasting a portable device. In particular the present invention relates to the use of a superabsorbent polymer as ballast for a portable device with a ballast fillable base.

2. Description of Related Art

Superabsorbent polymers are polymers that can absorb and retain as much as 500 (or more) times their own weight in liquid. Water absorbing polymers, i.e. hydrogels, are capable of forming a stable gel by the addition of water (or other water containing liquid) to a powdered, granulated, pulverized or the like form of the polymer. They are stable but can be broken with the addition of salt or other compositions to release their water. Superabsorbent polymers (SAP) are in generally available with a number of base polymers such as polyacrylate, polyacrylamide, ethylene maleic anhydride, carboxy-methyl-cellulose, polyvinyl alcohol, polyethylene oxide, polyacrylonitrile and many others including copolymer formulations of these polymers. In general, the SAPs have been readily available for at least 3 decades or more and represent a commercial approach to disposable hygienic products, blocking water penetration in underground power or communications cable, horticultural indications, control of fluid waste and spills, artificial snow, magic tricks, fire protection and a wide variety of other uses with some early uses as disposable bed liners.

Devices that are intended for portability but must remain in place during use are often affected by their use conditions which, absent a means of keeping them in place, can cause them to tip over or at the very least move. Such forces as wind, hitting or bumping of the device, the fact that they are top heavy or just light-weight and the like can cause a device to topple or move from its originally intended location fairly easily. For example, portable basketball goals, umbrella stands, volleyball net posts, traffic barriers, signs (especially outdoor type signs), trash cans, lights, satellite dishes and stands of all sorts and the like can all suffer from this problem. While these devices can be moved to a location and then staked to the ground it has become commonplace in the last few decades to place some form of a ballast base on the device. A ballast base provides a container for adding a ballast material such that the device can be weighted at the bottom and the ballast material easily removed if desired. It also provides a way of selling these devices as lightweight devices and allowing the customer to fill the ballast container with cheap material to add the necessary weight to the device. One very common type of ballast material used for portable devices having a ballast base is dry granular sand. Sand is relatively moderately inexpensive, heavy and is compatible with almost all types of material that a ballast container is usually made from. It is relatively difficult to add the sand to the ballast base through the small opening. It is also relatively difficult to remove the sand from the ballast base and the sand needs to be stored when not inside a particular ballast base. Water is the other common ballast material. Water is very cheap, plentiful, heavy and readily available. It can be disposed of after use and thus, does not have the storage and cost problems associated with sand. Water does need a water resistant ballast container such as a polymer or a treated metal to prevent rusting or other oxidative process from creating a hole in the ballast base. The further problem with ballast bases containing water, however, in spite of the attractiveness of water as a ballast material, is the fact that even the slightest of holes in the ballast container will allow the water to leak from the container. As attractive as water is as ballast material, for a variety of reasons sand is frequently preferred despite a cost and storage problem, to prevent leak problems since holes in a device that is frequently moved is a relatively common occurrence. While the design of the ballast base has undergone a variety of design changes over the last 30 years the ballast material available for use in these bases has remained largely unchanged.

### BRIEF SUMMARY OF THE INVENTION

It has been discovered that the problems of the prior art that are long standing and in some cases over 30 years old can be overcome. The use of a super absorbent polymer mixed with water forms a gel material inside the ballast base of an upright device and solves these extremely long standing problems associated with fillable ballasts for portable devices. The gel provides a cheap and easy way to fill the ballast base since only a small amount of polymer needs to be used compared to, for example, sand. The gel also provides a material that when mixed with water does not leak out small cracks or pinholes in a ballast base and thus, is far superior for this use than water alone.

Thus in one embodiment of the present invention, there is system for providing ballast weighting to a portable upright device comprising:
a) a portable upright device having a fillable ballast base; and
b) super absorbent polymer sufficient to fill the base when mixed with water.

In yet another embodiment of the present invention, there is disclosed a method of providing ballast to an upright device having a fillable ballast base comprising adding to the fillable ballast base sufficient super absorbent polymer that when mixed with water fills the ballast base with a gelled polymer.

And in yet another embodiment of the present invention, there is disclosed an upright portable device having a ballast base filled with a gel comprising a superabsorbent polymer and water.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “upright portable device” refers to any device which uses a fillable ballast base to weigh the device down since the device is portable and not fixed to the ground or otherwise fixed in place. The device may need to be weighed down to prevent movement from such things as wind, contact, accidents or any occurrence that causes the device to move. The ballast base is a substitute for a fixed base and the ballast base can be drained for making it portable once again. Examples of portable upright devices include but are not limited to sporting devices such as basketball hoops, volleyball net uprights, football goalposts and the like; traffic devices such as traffic barriers and signs; portable advertising signs; umbrella stands and the like. Any device with a fillable ballast base is included in the definition of portable device.

The term “fillable ballast base” refers to those bases designed for portable devices which can be filled with sand or water for providing ballast. The ballast base is not in of itself novel and is well known and varying size and shapes are within the skill in the art for use in the present invention. It should be observed that since the current embodiment resists water leaking from the base it is possible to have a ballast base with cracks, holes or the like and still work. Accordingly, a ballast base that is designed for use with just water but has developed leaks could now be used with the present invention in a form of repair use of the device. The gel of the present invention would then seal at least minor leaks such as from pinholes or cracks. Armed with the present invention disclosure one of skill in the art could easily determine which fillable bases could utilize the present invention for repair. It is clear that the base would need to have an opening for the addition of both polymer and water but at the present there are no ballast bases which do not have that feature. Clearly, though, an existing ballast base, not specifically designed for use with the present invention, could have holes or resealable openings put in the existing base to accommodate the present invention. Such addition is within the skill of the art in view of the present disclosure.

As used herein the term “super absorbent polymer” (SAP) refers to any polymer that can mix with water and solidify (such as a gel). For the purposes of claims herein the term “gel” will refer to any solidifying that occurs with the addition of water to a super absorbent polymer and not just the classic term for gels, although gels by themselves are also within the scope of the present invention. Examples of super absorbent polymers which can be used in the present invention include, but are not limited to, polyacrylamide copolymer, ethylene maleic anhydride copolymer, cross linked carboxy-methyl-cellulose, polyvinyl alcohol copolymer, cross-linked polyethylene oxide, starch grafted copolymer of polyacrylonitrile, polyacrylate and the like. The SAP is usually a polymeric powder form since once combined with water the gellation process begins. The powdered form allows the polymer to be surrounded by water molecules swell and gel. The total absorbency and swelling capacity are controlled by the type and degree of crosslinking in the individual polymer or combinations of polymers used in the present invention. Accordingly, the ration of polymer to water will be different for each polymer selected, however, one skilled in the art would easily be able to determine ratios of water to polymer for any given super absorbent polymer used in the present invention.

The gel can have other compositions added to the polymer the water or both. For example, an anti-microbial agent could be added to the polymer or water to incorporate the agent into the final gel. Thus, when the water is not sterile or the inside of the base is not sterile the growth of mold bacterial or the like is much less likely than without such an additive. Also, where clear bases are used a coloring agent could be added. Other additives such as fragrance, thermochromic materials, and the like could also be added to the system or individual components of the system including the water.

The gels used in the present invention can be un-gelled (deactivated) for draining of the polymer and water from the ballast base. While the gel can be scooped out of a large opening or poured out if the opening is much smaller or if removal as a gel is inconvenient then breaking the gel is advantageous. Each gel can be broken (deactivated) differently and such is within the skill in the art but, for example, polyacrylates can be broken back to a liquid by the addition of salt to the gel. The liquid then can easily be poured out of any hole originally intended to pour liquid or sand out of. Once the gel is removed from the base the device can then be transported like use with other standard ballast materials.

### Example

A portable basketball net and pole with a fillable ballast base designed to be filled with water during use is selected. The volume of the base is approximately 46 gallons (12.2 L) of water. The portable basketball hoop is positioned for use. Approximately 16 ounces (453 g) of a polyacrylate super absorbent polymer H2Old BaseGel is placed in the base and water is added to fill the base. After approximately 2-3 minutes the base is ready to use and the water has formed a firm, stable gel material. After use a salt/water, sodium chloride & water, is added to the gel and the gel liquefies. The liquid is then drained from the ballast base and the basketball hoop put away until the next use.

The above examples are not intended to be limiting to the invention. Variations in the super absorbent polymer, the portable upright device and the like are all within the scope of the claims which follows.

What is claimed is:

1. A system for providing ballast weighting to a portable upright device comprising:
a) a portable upright device having a fillable ballast base; and
b) super absorbent polymer sufficient to fill the base when mixed with water.

2. A system according to claim 1 wherein the mixture in the base further comprises an anti-microbial agent.

3. A system according to claim 1 wherein the super absorbent polymer is a polyacrylate.

4. A method of providing ballast to an upright device having a fillable ballast base comprising adding to the fillable ballast base sufficient super absorbent polymer that when mixed with water fills the ballast base with a gelled polymer.

5. The method according to claim 4 which further comprises the addition of an antimicrobial agent to the base.

6. The method according to claim 4 wherein the super absorbent polymer is a polyacrylate super absorbent polymer.

7. An upright portable device having a ballast base the ballast base filled with a gel comprising a superabsorbent polymer and water.
